(19) United States
(12) Patent Application Publication
(10) Pub. No.: US 2021/0363652 A1
(43) Pub. Date: Nov. 25, 2021

(54) MULTILAYER TRANSITION JOINT FOR ALUMINUM SMELTER AND METHOD OF MAKING

(71) Applicant: DMC Global Inc., Broomfield, CO (US)

(72) Inventor: David Gauthier, Villelongue de la Salanque (FR)

(73) Assignee: DMC Global Inc., Broomfield, CO (US)

(21) Appl. No.: 17/045,291

(22) PCT Filed: Apr. 4, 2019
(86) PCT No.: PCT/US19/25745

§ 371 Date: Oct. 5, 2020

Related U.S. Application Data
(60) Provisional application No. 62/653,171, filed on Apr. 5, 2018.

(51) Int. Cl. C25C 3/08; B23K 20/16; B32B 15/01; B23K 20/08; B23K 20/227

(52) U.S. Cl. CPC C25C 3/08; B23K 20/16; B32B 15/012; B23K 2103/20; B23K 20/2275; B32B 15/013; B23K 20/08

(57) ABSTRACT

A composite transition joint is described. The transition joint includes a plurality of metal layers that are metallurgically bonded together. The metal layers include a base layer, an interlayer bonded to the base layer, and a top layer bonded to the interlayer. The top layer includes an aluminum manganese alloy and includes a thickness of at least 15 mm. The composite transition joint may bond a current stem to an anode of an aluminum smelter. The transition joint increases the length of the current stem, without impacting electrical conductivity of the current stem.

This application claims the benefit of U.S. Provisional Patent Application No. 62/653,171 filed on Apr. 5, 2018, which is incorporated by reference for all purposes in its entirety herein.

### FIELD OF THE DISCLOSURE

A multilayer transition joint with increased thickness is generally described. More specifically, this invention relates to an aluminum smelter including a current stem including a multilayer transition joint with increased thickness.

### BACKGROUND OF THE DISCLOSURE

An electrolytic reduction process is typically used to produce aluminum. The process includes the placement of alumina or aluminum oxide in a Hall-Heroult reduction cell having a cryolite electrolyte. The reduction cell is typically operated at low voltages, and with very high electrical currents. The electrical current first enters the reduction cell through an anode structure, and then passes through a cryolite bath before entering a cathode block. The electrical current is passed through the cell, which electrochemically reduces the aluminum oxide, split by the electrolyte into aluminum ions and oxygen ions. The oxygen ions are reduced to oxygen at the anode, while the aluminum ions move to the cathode where they accept electrons supplied by the cathode. The resulting metallic aluminum accumulates as a liquid metal pad on the cathode surface.

The anode structure is connected to a current stem/busbar, which helps to suspend the anode structure in the reduction cell. The current stem typically includes a transition joint that is welded/bonded to an aluminum side of the stem and is bonded to a steel side (or steel yoke) that is connected to the anode. Transition joints include two or more layers of dissimilar metals that are adhered together. Each dissimilar metal may be able to retain its individual mechanical, electrical and corrosion properties.

The length of the stem is also of particular importance as it helps to adjust the distance between the anode and the molten aluminum. In the anode assembly, the transition joint can be considered as a mechanical and electrical fuse, which sometime needs replacement after some severe treatments, and general wear and tear of the stem. Replacement involves separating the transition joint from the stem by sawing the welded/bonded area, which sometimes includes cutting a portion of the bottom of the stem. These repeated repairs result in a stem that gets shorter each time the joint is replaced. Over the years, the anode assembly goes through multiple transition joints changes, multiple length reductions, until the stem becomes too short, and is out of the required tolerances.

Therefore, there is a need for a thicker/longer transition joint that facilitates the formation of a longer aluminum stem for an aluminum smelter. There is also a need for a transition joint with increased thickness that also maintains the electrical conduction performance of the anode, while also avoiding stem scrapping due to short length.

### BRIEF DESCRIPTION OF THE EXEMPLARY EMBODIMENTS

The present embodiments may be associated with a multilayer composite transition joint. The transition joint includes a plurality of metal layers that may be bonded together. The metal layers may include a base layer, and interlayer abutting the base layer, and a top layer that abuts the interlayer. According to some embodiments, the base layer includes steel and the top layer includes an aluminum manganese alloy. The interlayer may be sandwiched between the base and top layers, and may include a metal that differs from at least one of the base layer and the top layer. The top layer may include a thickness of at least about 15 mm, which may help to increase the overall thickness of the transition joint.

Further embodiments of the present disclosure may be associated with an aluminum smelter for producing aluminum. The aluminum smelter may include a cell/chamber, as well as several components at least partially disposed in the cell. Such components may include an electrically-conductive cathode including a plurality of cathode blocks that form a base of the cell. According to an aspect, the aluminum smelter also includes at least one anode suspended within the cell. The anode may be suspended by virtue of being connected to a current bar/stem that extends from an electrical busbar system into the cell, with the anode being connected at its end furthest away from the electrical busbar system. The stem may include one or more layers of an electrically conductive metal adjacent the busbar system and a multilayer transition joint between the electrically conductive metal and the anode. The composite transition joint may include a top layer of metal including a thickness of at least about 15 mm. The top layer of metal is an aluminum manganese alloy. Increases in the thickness of the transition joint helps to increase the length of the current stem, and reduces the frequency of its replacement.

Embodiments of the present disclosure further relate to a method for making a multilayer composite transition joint for use in an aluminum smelter. The method includes positioning a plurality of metal layers in a cell/chamber/package. The metal layers may include a base layer including steel, an interlayer including a metal that differs from the base layer, and a top layer including an aluminum manganese alloy and including a thickness of at least about 15 mm. The interlayer may be positioned in a spaced apart configuration from the base layer, and the top layer may be placed in a spaced apart configuration from the interlayer. Once the base layer, intermediate layer and the top layers are positioned in the cell, they are bonded together. The step of bonding the layers may be performed according to any know bonding techniques, such as explosion bonding, roll bonding and any known mechanical or chemical bonding technique.

### BRIEF DESCRIPTION OF THE DRAWINGS

A more particular description will be rendered by reference to specific embodiments thereof that are illustrated in the appended drawings. Understanding that these drawings depict only typical embodiments thereof and are not therefore to be considered to be limiting of its scope, exemplary embodiments will be described and explained with additional specificity and detail through the use of the accompanying drawings in which:

FIG. 1A is a side cross-section of a transition joint, according to some embodiments;

FIG. 1B is a side cross-sectional view of a transition joint including two top layers, according to some embodiments;

FIG. 2 is a cross-sectional view of an aluminum smelter including a current stem including a transition joint, according to some embodiments;

FIG. 3 is flow chart illustrating a method of making a multilayer composite transition joint, according to some embodiments; and

FIG. 4 is a chart illustrating the mechanical strength of a transition joint made according to some embodiments and a standard transition joint, after exposure to higher temperatures.

Various features, aspects, and advantages of the embodiments will become more apparent from the following detailed description, along with the accompanying figures in which like numerals represent like components throughout the figures and text. The various described features are not necessarily drawn to scale, but are drawn to emphasize specific features relevant to some embodiments.

The headings used herein are for organizational purposes only and are not meant to limit the scope of the description or the claims. To facilitate understanding, reference numerals have been used, where possible, to designate like elements common to the figures.

### DETAILED DESCRIPTION

Reference will now be made in detail to various embodiments. Each example is provided by way of explanation, and is not meant as a limitation and does not constitute a definition of all possible embodiments.

As used herein, “metallurgical bond” refers to the ability of each metal or layer of metal of a composite/multilayer transition joint to maintain metallurgical continuity with each adjacent metal layer.

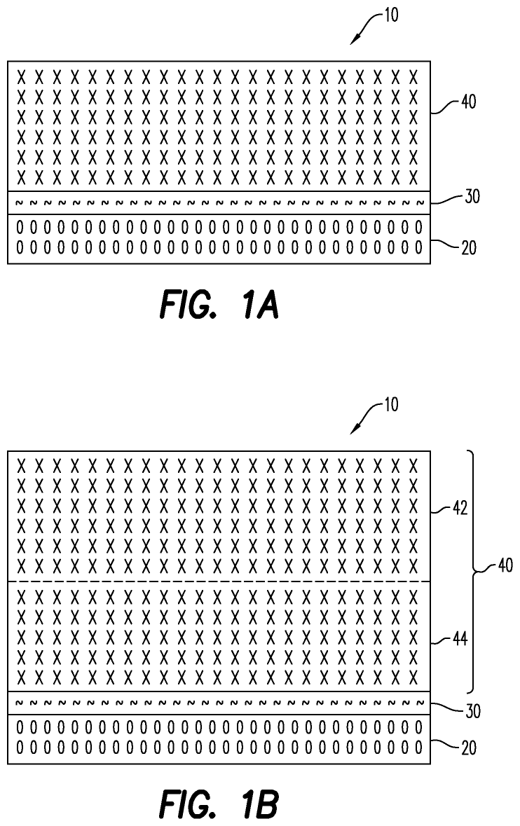

FIGS. 1A-1B illustrate embodiments of a composite transition joint/multilayer composite transition joint 10. The composite transition joint 10 may include a combination of materials that are specially arranged so that the transition joint 10 maintains its metallurgical bond so that the bonded interface between the materials is not modified or damaged by temperatures of up to about 600° C. (no failure mode when the transition joint 10 is exposed to this increased temperature, and is tested at room temperature). The transition joint 10 may maintain its metallurgical bond when exposed to temperatures of up to about 600° C. for up to 24 hours.

The composite transition joint 10 may include a base layer 20, an interlayer 30 and a top layer 40. Each layer may include a different material than the adjacent layer. For example, the layers may include metals that are typically incompatible with each other, but are metallurgically bonded in a manner where each layer of metal retains its initial physical and/or mechanical properties, such as strength, conductivity, corrosion, and the like. Various methods may be utilized to metallurgically bond each of the layers together, as is described in further detail herein below.

According to some embodiments, the base layer 20 includes steel. In an embodiment, the base layer 20 includes carbon steel. The type of material selected for the base layer 20 may be based, at least in part, on the type of material that the base layer 20 will be bonded/secured to. The base layer 20 may include a thickness of at least about 35 mm.

The interlayer 30 may be metallurgically bonded to the base layer 20, and may include a metal that is different from the base layer 20. In other words, the interlayer 30 may not include steel or carbon steel. According to an aspect, the interlayer 30 includes one of titanium and chromium. According to some embodiments, the interlayer may be nickel or tantalum. The type of metal selected to form the interlayer 30 may be based at least in part on its ability to prevent the formation of intermetallics between the layers, and may allow the stem to be heated to greater temperatures (in some conditions up to 600° C.) without failing. If the base layer 20 was bonded directly to the top layer 40, such as, aluminum and steel being bonded directly to each other, this would result in a reaction between the base and top layers 20, 40. The interlayer 30 may include a thickness up to about 5 mm. The interlayer 30 may be about 0.1 μm to about 5 mm thick. According to an aspect, the interlayer 30 is joined with the base layer 20 in such a manner that the bond line or the point of adherence between them is not visible to the naked eye.

The top layer 40 may be metallurgically bonded to the interlayer 30. As illustrated in FIG. 1A, the top layer 40 may be arranged in a manner whereby the interlayer 30 may be sandwiched between the base layer 20 and the top layer 40. While the top layer 40 may include various types of aluminum, it has been found that the utilization of an aluminum manganese alloy may help to increase the overall thickness of the transition joint 10 without impacting the strength of the transition joint 10. According to some embodiments, the top layer 40 (which includes the aluminum manganese alloy) includes a tensile strength of about 16 ksi/110 MPa to about 41 ksi/283 MPa. The top layer 40 may be able to serve as a base alloy that bonds well with aluminum and/or other aluminum alloys.

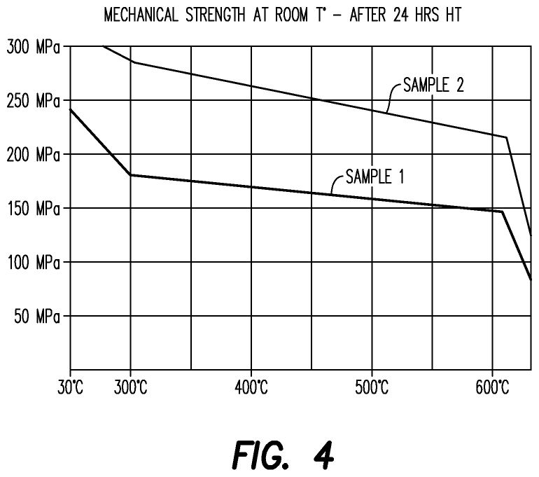

As would be understood by one of ordinary skill in the art, aluminum alloys are categorized into a number of groups based on the particular material's characteristics. Such characteristics may include the aluminum alloy's ability to respond to thermal and mechanical treatment/stresses. The type of metal selected to form the top layer 40 may be important, particularly because of the differences in the characteristics and properties of aluminum alloys, and the differences in their abilities to perform well in different applications. As illustrated in FIG. 4, the incorporation of aluminum manganese in the top layer 40 of the composite transition joint 10 (Sample 2) helps to provide the transition joint 10 with increased mechanical strength even after exposure to higher temperatures. According to some embodiments, the composite transition joint 10 is able to maintain a tensile strength of up to about 300 MPa at room temperature. The composite transition joint 10 may also be able to maintain a tensile strength of up to about 250 MPa after being exposed to a temperature of about 300° C., which is greater than the tensile strength of the aluminum of a standard stem, as illustrated (Sample 1) in FIG. 4.

According to some embodiments, the top layer 40, which includes aluminum manganese, includes a thickness of at least about 15 mm. The aluminum manganese alloy may allow the transition joint 10 to withstand excessive strain, particularly in the top layer 40, so that the transition joint 10 and/or structures to which the transition joint 10 may be secured does not require frequent and expensive replacement and includes increased strength and stiffness, which may be highly desirable in the aluminum smelting industry. According to some embodiments, the transition joint 10 and the structures to which the transition joint 10 is secured may be able to maintain their increased strength and stiffness at elevated temperatures. Such elevated temperatures may be up to about 550° C., alternatively up to about 350° C. which, in some embodiments, is the standard running temperature of an aluminum smelter.

The thickness of the top layer 40 may help to facilitate a thicker composite transition joint 10. According to some embodiments, the top layer 40 may be up to about 80% of a total thickness of the composite transition joint 10. Alternatively, the thickness of the top layer 40 may be from 40% to 70%, alternatively from about 25% to about 40% of a total thickness of the composite transition joint 10. Alternatively, the thickness of the top layer 40 may be at least about 50% of the total thickness of the composite transition joint 10. The total thickness of the composite transition joint 10 may be based on the application in which the transition joint 10 is to be utilized. According to some embodiments, the base layer 20 includes a thickness of at least about 35 mm, the interlayer 30 includes a thickness of about 2 mm, and the top layer 40 includes a thickness of at least about 20 mm. The base layer 20 may include a thickness of at least 10 mm.

FIG. 1B illustrates the top layer 40 including a plurality of top layers 40. According to some embodiments, the top layer may include a first top layer 42 and a second top layer 44. The second top layer 44 is bonded to the interlayer 30, while the first top layer 42 is directly bonded to the second top layer 44. The second top layer 44 may be sandwiched between and may be directly bonded to each of the interlayer 30 and the first top layer 42. In some embodiments, the first and second top layers 42, 44 may include a combined thickness of at least about 15 mm. It is contemplated that the first and second top layers 42, 44 may include a same thickness or a different thickness. For example, the first top layer 42 may include a thickness of 7.5 mm and the second top layer 44 may include a thickness of 7.5 mm. According to some embodiments, at least one of the first and second top layers 42, 44 include a thickness of at least about 15 mm, which may provide for a combined thickness that is greater than 15 mm.

Further embodiments of the present disclosure are associated with an aluminum smelter 200. The aluminum smelter 200 may include a cell 210 that houses several components and structures that aid in the production/manufacturing of aluminum.

The aluminum smelter 200 includes an electrically-conductive cathode 220 including a plurality of cathode blocks 222 that form a base 230 of the cell 210. A high temperature liquid 202 may be contained within the cell 210. The high temperature liquid may cover the base 230 and at least partially fills the cell 210. The high temperature liquid may be a liquid electrolyte, which includes both aluminum and oxygen ions to be separated in the Hall-Heroult process.

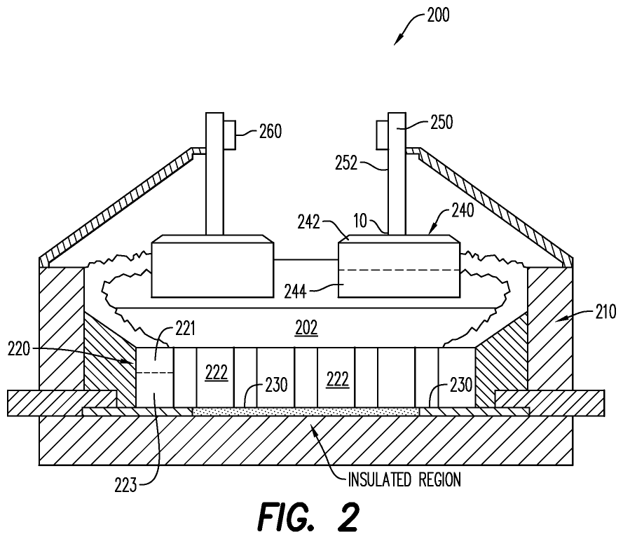

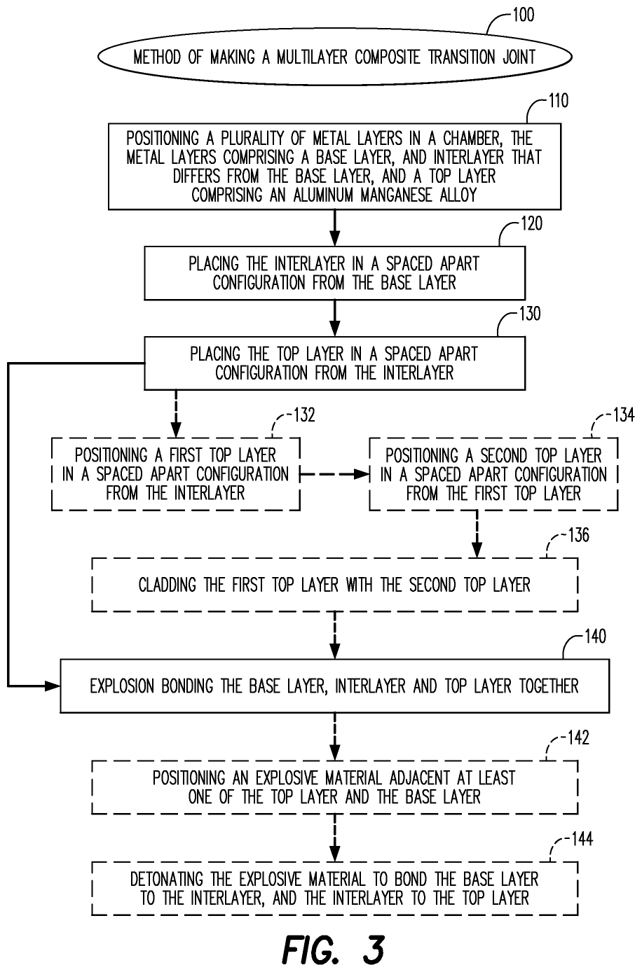

The aluminum smelter 200 further includes at least one anode 240. The anode 240 may be suspended within the cell 210 and may be spaced apart from the cathode 220, and thus the base 230 of the cell 210. According to some embodiments, the anode 240 includes an upper portion 242 and a lower portion 244. As illustrated in FIG. 2, the upper portion 242 may be isolated from the high temperature liquid 202, while the lower portion 244 may be in contact with the high temperature liquid 202. The upper portion 242 of the anode 240 may include a highly conductive metal including at least one of copper, aluminum, and alloys thereof, while the lower portion 244 of the anode 240 may include a refractory material. According to an aspect, the lower portion 244 may include steel or ceramics.

As illustrated in FIG. 2 and in an embodiment, the aluminum smelter includes at least one current stem 250. The current 250 stem may extend between an electrical busbar system 260 and the anode 240, and may include a length of about 2.5 meters. The electrical busbar system 260 may be in electrical communication with the current stem 250 and the anode 240, which may help to pass an electrical current through the cell 210. According to an aspect, the current stem 250 establishes and maintains electrical conduction with the electrical busbar system 260. The current stem 250 may be received within recesses (not shown) formed in each anode block 240. The recess may keep the current stem 250 secured with the anode block 240. According to an aspect, the current stem 250 includes one or more layers of an electrically conductive metal 252 adjacent the busbar system 260, and a multilayer/composite transition joint 10 between the electrically conductive metal 252 and the anode 240. The multilayer transition joint 10 is substantially similar to the multilayer transition joint 10 illustrated in FIGS. 1A-1B, and described hereinabove. Thus, for purposes of convenience and not limitation, the various features, attributes, and arrangement of the multilayer transition joint 10, where similar to the various features, attributes, and arrangement of the multilayer transition joint 10 discussed in connection with FIGS. 1A-1B are not repeated here.

The transition joint 10 may include a top layer 40 including an aluminum manganese alloy. According to some embodiments, the transition joint 10 includes a base layer 20 coupled to the anode 240 and an interlayer 30 coupled to the base layer 20. The interlayer 30 may be coupled to/extend between the top layer 40 and the base layer 20, while the top layer 40 may extend between the interlayer 30 and the electrically conductive metal 252. The top layer 40 may include a first top layer 42, and a second top layer 44 bonded or extending from the first top layer 42.

In an embodiment, the top layer 40 includes a thickness of at least about 15 mm. As described hereinabove, the top layer 40 may include first and second top layers 42, 44, which may collectively include a combined thickness of at least about 15 mm. The composite transition joint 10 may be up to about 1% to about 2% of the length of the current stem 250. Thus, the composite transition may include a total thickness of between about 20 mm to about 50 mm. According to some embodiments, the top layer 40 is up to about 70% of the total thickness of the composite transition joint 10, alternatively from about 40% to about 70% of the total thickness of the composite transition joint 10, alternatively up to about 30% of the composite transition joint 10.

The top layer 40 of the composite transition joint 10 may be of greater electrical conductivity than the base layer 20, and therefore an increased thickness of the top layer 40 does not negatively impact the electrical conductive properties of the transition joint 10 and/or the current stem 250. The composite transition joint 10, with its increased thickness, may help lengthen traditionally short current stems, without affecting the electrical efficiency of the aluminum smelter 200. The top layer 40 of the composite transition joint 10 is of similar electrical performance as the stem 250, therefore, increased thickness of the top layer 40 compensates a shorter stem, without reducing or negatively impacting the electrical performance of the stem 250.

Embodiments of the present disclosure further relate to a method 100 of making a multilayer composite transition joint for use in an aluminum smelter. The composite transition joint and the aluminum smelter are substantially similar to the multilayer transition joint illustrated in FIGS. 1A-1B, and the aluminum smelter illustrated in FIG. 2, each of which is described hereinabove. Thus, for purposes of convenience and not limitation, the various features, attributes, and arrangement of the composite transition joint and the aluminum smelter, where similar to the various features, attributes, and arrangement of the composited transition joint and the aluminum discussed in connection with FIGS. 1A-1B and 2 are not repeated here.

The method 100 includes positioning 110 a plurality of metal layers in a cell/chamber. The metal layers include a base layer, an interlayer, and a top layer. The base layer may include steel, while the interlayer includes a metal that differs from the base layer (such as titanium and chromium), and the top layer includes an aluminum manganese alloy. As described hereinabove, with reference to FIGS. 1A-1B, the aluminum manganese alloy includes a thickness of at least 15 mm. According to some embodiments, in the step of positioning 110, the interlayer is placed 120 in a spaced apart configuration from the base layer, and the top layer is placed 130 in a spaced apart configuration from the interlayer. The top layer may include at least a first layer and a second layer, with the first top layer being positioned 132 in a spaced apart configuration from the interlayer, and the second top layer being positioned 134 in a spaced apart configuration from the first top layer. In this configuration, the first top layer is between the interlayer and the second top layer, and the first and second top layers collectively includes a thickness of at least 15 mm.

The base layer, interlayer and top layer (or first and second top layers) are all bonded 140 together, to form a transition joint including an increased thickness, while maintaining electrical conduction performance of the stem to which the transition joint is bonded. It is contemplated that the first and second top layers may first be bonded together using a cladding 136 technique, prior to being bonded 140 with the base layer and interlayer. According to some embodiments, the step of bonding 140 the layer together includes at least one of explosion bonding, roll bonding and chemical bonding. When explosion bonding is utilized, the method 100 includes positioning 142 an explosive material adjacent at least one of the top layer and the base layer, and detonating 144 the explosive material. As would be understood by one of ordinary skill in the art, more than one detonating 144 steps may be performed to achieve the desired bond/cohesion/adhesion between the layers. When the explosive material is detonated, the layers are propelled together, which metallurgically bonds the base layer to the interlayer, and the interlayer to the top layer.

### EXAMPLE

Sample transition joints were generally configured to test their mechanical strengths after exposure to elevated temperatures. The transition joints include multiple layers of metal, each layer being bonded to an adjacent layer by an explosion clad welding process. The sample transition joints were then placed in ovens, each oven having a set temperature of 30° C., 300° C., 400° C., 500° C. or 600° C. After 24 hours, each sample was removed, cooled to room temperature, and their tensile/mechanical strengths were tested.

Sample 1 was a transition joint including a layer of steel, a layer of un-alloyed aluminum (such as 1000 series grade aluminum) having a thickness of 12.7 mm, and a layer of titanium sandwiched therebetween. Sample 2 was a transition joint including a base layer of steel, an interlayer of titanium, and a top layer of an aluminum manganese alloy having a thickness of 23.0 mm. Both samples were exposed to elevated temperatures. After being exposed to 600° C. for 24 hours, Sample 1 had a tensile strength of about 150 MPa, while Sample 2 had a tensile strength of above 200 MPa.

The present disclosure, in various embodiments, configurations and aspects, includes components, methods, processes, systems and/or apparatus substantially developed as depicted and described herein, including various embodiments, sub-combinations, and subsets thereof. Those of skill in the art will understand how to make and use the present disclosure after understanding the present disclosure. The present disclosure, in various embodiments, configurations and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

In this specification and the claims that follow, reference will be made to a number of terms that have the following meanings. The terms “a” (or “an”) and “the” refer to one or more of that entity, thereby including plural referents unless the context clearly dictates otherwise. As such, the terms “a” (or “an”), “one or more” and “at least one” can be used interchangeably herein. Furthermore, references to “one embodiment”, “some embodiments”, “an embodiment” and the like are not intended to be interpreted as excluding the existence of additional embodiments that also incorporate the recited features. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Terms such as “first,” “second,” “upper,” “lower” etc. are used to identify one element from another, and unless otherwise specified are not meant to refer to a particular order or number of elements.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

As used in the claims, the word “comprises” and its grammatical variants logically also subtend and include phrases of varying and differing extent such as for example, but not limited thereto, “consisting essentially of” and “consisting of” Where necessary, ranges have been supplied, and those ranges are inclusive of all sub-ranges therebetween. It is to be expected that variations in these ranges will suggest themselves to a practitioner having ordinary skill in the art and, where not already dedicated to the public, the appended claims should cover those variations.

The terms “determine”, “calculate” and “compute,” and variations thereof, as used herein, are used interchangeably and include any type of methodology, process, mathematical operation or technique.

The foregoing discussion of the present disclosure has been presented for purposes of illustration and description. The foregoing is not intended to limit the present disclosure to the form or forms disclosed herein. In the foregoing Detailed Description for example, various features of the present disclosure are grouped together in one or more embodiments, configurations, or aspects for the purpose of streamlining the disclosure. The features of the embodiments, configurations, or aspects of the present disclosure may be combined in alternate embodiments, configurations, or aspects other than those discussed above. This method of disclosure is not to be interpreted as reflecting an intention that the present disclosure requires more features than are expressly recited in each claim. Rather, as the following claims reflect, the claimed features lie in less than all features of a single foregoing disclosed embodiment, configuration, or aspect. Thus, the following claims are hereby incorporated into this Detailed Description, with each claim standing on its own as a separate embodiment of the present disclosure.

Advances in science and technology may make equivalents and substitutions possible that are not now contemplated by reason of the imprecision of language; these variations should be covered by the appended claims. This written description uses examples to disclose the method, machine and computer-readable medium, including the best mode, and also to enable any person of ordinary skill in the art to practice these, including making and using any devices or systems and performing any incorporated methods. The patentable scope thereof is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

1. A multilayer composite transition joint comprising:
a base layer comprising steel;
an interlayer abutting the base layer, wherein the interlayer comprises a metal that differs from the base layer; and
a top layer abutting the interlayer, wherein the top layer comprises an aluminum manganese alloy and has a thickness of at least about 15 mm,
wherein the interlayer is bonded to the base layer and the top layer is bonded to the interlayer.

2. The composite transition joint of claim 1, wherein the top layer comprises from 40% to 70% of a total thickness of the composite transition joint.

3. The composite transition joint of claim 1, wherein the top layer comprises:
a first top layer; and
a second top layer, wherein the second top layer is sandwiched between the interlayer and the first top layer, and the first and second top layers include have a combined thickness of at least 15 mm.

4. The composite transition joint of claim 1, wherein the composite transition joint maintains its metallurgical bond after exposure to a temperature of up to about 600° C.

5. The composite transition joint of claim 1, wherein the interlayer comprises one of nickel, tantalum, and chromium.

6. The composite transition joint of claim 1, wherein the composite transition joint maintains a tensile strength of up to about 220 MPa at room temperature.

7. The composite transition joint of claim 1, wherein the composite transition joint maintains a tensile strength of at least 200 MPa after exposure to a temperature of up to about 550° C. for about 24 hours.

8. The composite transition joint of claim 1, wherein
the base layer has a thickness of at least about 10 mm;
the interlayer has a thickness of about 2 mm; and
the top layer has a thickness of at least about 15 mm.

9. An aluminum smelter comprising:
a cell;
a cathode comprising a plurality of cathode blocks, the cathode blocks forming a base of the cell;
at least one anode suspended within the cell; and
at least one current stem extending between an electrical busbar system and the anode, the stem comprising one of more layers of an electrically conductive metal adjacent the busbar system; and
a composite transition joint between the electrically conductive metal and the anode, the composite transition joint comprising a top layer including an aluminum manganese alloy and having a thickness of at least about 15 mm.

10. The aluminum smelter of claim 9, wherein the current stem establishes and maintains electrical conductivity with the electrical busbar system.

11. The aluminum smelter of claim 9, wherein the composite transition joint is about 1% to about 2% of a total length of the current stem.

12. The aluminum smelter of claim 9, wherein the cell contains a high temperature liquid, and at least a portion of the anode is in contact with the high temperature liquid.

13. The aluminum smelter of claim 9, wherein at least one of the anode and the cathode blocks comprises:
an upper portion; and
a lower portion, wherein the upper portion is isolated from the high temperature liquid, and the lower portion is in contact with the high temperature liquid.

14. The aluminum smelter of claim 13, wherein the upper portion of the anode comprises a highly conductive metal and the lower portion of the anode comprises a refractory material.

15. The aluminum smelter of claim 14, wherein the highly conductive metal comprises at least one of copper, aluminum, and alloys thereof

16. The aluminum smelter of claim 9, wherein the current stem is received within a recess formed in each anode block, and the electrical busbar system is in electrical communication with the current bar and the anode.

17. A method of making a multilayer composite transition joint for use in an aluminum smelter, the method comprising the steps of:
positioning a plurality of metal layers in a cell, wherein the metal layers include a base layer comprising steel, an interlayer comprising a metal that differs from the base layer, and a top layer comprising an aluminum manganese alloy having a thickness of at least above 15 mm, and wherein the step of positioning comprises
placing the interlayer in a spaced apart configuration from the base layer, and
placing the top layer comprising the aluminum manganese alloy in a spaced apart configuration from the interlayer; and
bonding the base layer, the interlayer and the top layer together.

18. The method of claim 17, wherein the top layer comprises at least a first top layer and a second top layer, wherein at least one of the first and second top layers has a thickness of at least 15 mm.

19. The method of claim 18, wherein the step of placing the top layer in a spaced apart configuration from the interlayer comprises the steps
positioning the first top layer in a spaced apart configuration from the interlayer, and
positioning the second top layer in a spaced apart configuration from the first top layer, so that the first top layer is between the interlayer and the second top layer; and
the method further comprising cladding the first top layer to the second top layer.

20. The method of claim 17, wherein the bonding comprises at least one of explosion bonding, roll bonding, mechanical bonding, and chemical bonding.
